(19) United States
(12) Patent Application Publication
(10) Pub. No.: US 2011/0157698 A1
(43) Pub. Date: Jun. 30, 2011

(54) RETARDATION PLATE FOR STEREOSCOPIC IMAGE DISPLAY, POLARIZING ELEMENT, AND METHODS FOR PRODUCTION THEREOF, AND STEREOSCOPIC IMAGE DISPLAY DEVICE

(75) Inventor: Hiroyuki Yoshimi, Osaka (JP)

(73) Assignee: NITTO DENKO CORPORATION, Osaka (JP)

(21) Appl. No.: 12/966,066

(22) Filed: Dec. 13, 2010

(30) Foreign Application Priority Data
Dec. 25, 2009 (JP) 2009-295776

(51) Int. Cl. G02B 27/22; G02B 5/30; B29D 7/01

(52) U.S. Cl. 359/462; 359/489.07; 264/1.34

(57) ABSTRACT

There are provided an easily producible retardation plate for forming a stereoscopic image and a stereoscopic image display device and a stereoscopic image display system produced therewith. A retardation plate for forming a stereoscopic image has a plurality of first retardation regions and a plurality of second retardation regions in the same plane. The first retardation regions have an in-plane retardation of (¼+m)λ at a wavelength λ, and the second retardation regions have an in-plane retardation of (¾+n)λ at a wavelength λ, wherein m and n are each 0 or a natural number, preferably m=n=0. The first and second retardation regions have slow axis directions parallel to each other.

### BACKGROUND OF THE INVENTION

1. Field of the Invention

The invention relates to a retardation plate and a polarizing element suitable for stereoscopic image display, and methods for production thereof. The invention also relates to a stereoscopic image display device produced with the retardation plate or the polarizing element. The invention also relates to polarizing glasses for stereoscopic view of the stereoscopic image display device and to a stereoscopic image display system including a combination of the stereoscopic image display device and the polarizing glasses.

2. Description of the Related Art

A proposed method for displaying a stereoscopic image includes producing an image for the right eye (right-eye image) and an image for the left eye (left-eye image) with different states of polarization and viewing the images through stereoscopic glasses including right and left eyeglass portions. According to this method, the right eye sees only the right-eye image, and the left eye sees only the left-eye image, so that the viewer perceives a three-dimensional image due to the binocular parallax. More specifically, an image display device produces a right-eye image in a first state of polarization and a left-eye image in a second state of polarization, and the images are viewed through polarizing glasses including: a left eyeglass portion including a first polarizing plate capable of transmitting light in the first state of polarization and blocking (absorbing or reflecting) light in the second state of polarization; and a left eyeglass portion including a second polarizing plate capable of blocking light in the first state of polarization and transmitting light in the second state of polarization, so that stereoscopic display is made possible.

For example, Japanese Patent Application Laid-Open (JP-A) No. 58-184929 proposes a method of producing such two types of images in different states of polarization from a single image display device, in which a polarizing plate having first and second regions whose transmission axis directions are perpendicular to each other is attached firmly to the front surface of a display device.

There is also proposed a method that includes using a retardation plate having first and second regions in combination with a polarizing plate having a uniform transmission axis to form a structure in which the transmission axis directions of images produced at the first and second regions are perpendicular to each other. For example, JP-A No. 2001-59948 proposes a method including using a polarizing plate having a uniform transmission axis in combination with a retardation plate having a patterned first region with a retardation of a half-wavelength (λ/2) and a patterned second region with no retardation, and placing them so that the slow axis direction of the first region makes an angle of 45° with the transmission axis direction of the polarizing plate so that the plane of vibration of polarized light at the first region is made perpendicular to the plane of vibration of polarized light at the second region. JP-A No. 2002-14301 proposes a method of using a polarizing plate and a retardation plate including: a first region having an optical rotation element capable of rotating the plane of vibration of polarized light by 90°; and a second region with the rotation element removed.

According to these methods, for example, right- and left-eye images are output from the first and second regions, respectively, and the images are viewed through stereoscopic polarizing glasses including: a right eyeglass portion including a first polarizing plate capable of transmitting polarized light from the first region and blocking light in the second state of polarization; and a left eyeglass portion including a second polarizing plate having a transmission axis direction perpendicular to that of the first polarizing plate, so that stereoscopic display is made possible. However, when two types of polarized light perpendicular to each other are output for the right- and left-eye images, the transmission axis directions of the right- and left-eye images have to be exactly aligned with the transmission axis directions of the polarizing plates of the polarizing glasses worn by the viewer. Therefore, if the position or face angle of the viewer or the state in which the polarizing glasses are worn varies, the right- and left-eye images will be viewed by the respective eyes in a blended manner, which makes the stereoscopic image unclear.

From this point of view, there is proposed a method of outputting circularly polarized light beams with opposite polarities (right-and left-handed circularly polarized light beams) from first and second regions. For example, JP-A No. 10-227998 proposes a laminated retardation plate including: a first retardation member having a patterned first region with a retardation of a half-wavelength and a patterned second region with no retardation; and a second retardation member having a retardation of a quarter-wavelength (λ/4), wherein the first and second retardation members are placed so that their slow axes are perpendicular to each other. In this laminated retardation plate, the first region can have a retardation of +λ/4, while the second region can have a retardation of −λ/4, and therefore, when the polarizing plate axis directions make an angle of 45° in the laminate, circularly polarized light beams with opposite polarities can be output from the first and second regions, respectively.

When circularly polarized light beams with opposite polarities are output for a stereoscopic image as described above, the axis directions of the image display device and the stereoscopic polarizing glasses do not have to be aligned with one another, which makes stereoscopic view possible even when the position or face angle of the viewer or the state in which the polarizing glasses are worn varies. However, the method of using two retardation members as disclosed in JP-A No. 10-227998 requires a λ/2 plate to be patterned into two regions and further requires a λ/4 plate, which makes it complicate to produce the retardation plate due to a large number of components.

Under the circumstances, an object of the invention is to provide an easily producible retardation plate for use in stereoscopic image display.

### SUMMARY OF THE INVENTION

An embodiment of the invention is directed to a retardation plate having a plurality of first retardation regions and a plurality of second retardation regions in the same plane. The first retardation regions have an in-plane retardation of (¼+m)λ at a wavelength λ, and the second retardation regions have an in-plane retardation of (¾+n)λ at a wavelength λ, wherein m and n are each 0 or a natural number, preferably m=n=0. The first and second retardation regions have slow axis directions parallel to each other. According to the invention, the retardation plate having two regions with different retardations can be easily produced, because the slow axis directions of the first and second retardation regions are parallel to each other.

The retardation plate of the invention can be produced by a process including a first step of producing a film having a uniform in-plane retardation; and a second step of reducing the retardation of at least one of first and second regions corresponding to the first and second retardation regions, respectively. In this method, the film obtained in the first step preferably has an in-plane retardation equal to or more than (¼+m)λ and equal to or more than (¾+n)λ, and in the second step, the absolute value of the difference between the amounts of reduction in the retardation of the first and second regions is preferably (½+p)λ, wherein p is 0 or a natural number.

In a preferable embodiment of above method, the retardation of only one of the first and second regions is reduced in the second step.

The second step can be performed by reducing a molecular orientation degree so that the retardation of the region is reduced. Locally reducing a retardation can be achieved by locally applying heat, locally applying a liquid chemical capable of allowing the film to dissolve or swell, or the like.

In an embodiment of the invention, both of the first and second retardation regions preferably have in-plane retardations that increase with increasing wavelength in a visible light range (400 nm to 800 nm).

In another embodiment of the invention, the first and second retardation regions each include a plurality of sub-regions. Each sub-region of the first retardation region preferably has an in-plane retardation of (¼+m)λₖ at the main wavelength λₖ of light output from each subpixel of an image display device, and each sub-region of the second retardation region preferably has an in-plane retardation of (¾+n)λₖ at the main wavelength λₖ of light output from each subpixel of the image display device.

In a preferable embodiment, the first and second retardation regions are arranged in a stripe pattern.

Further, the invention is directed to a polarizing element including a laminate of a polarizing plate and above mentioned retardation plate. In a preferable embodiment of the polarizing element, a slow axis direction of the retardation plate makes an angle of 45° with a transmission axis direction of the polarizing plate.

Another embodiment of the invention is directed to a stereoscopic image display device including above mentioned retardation plate or polarizing element. The stereoscopic image display device of another embodiment of the invention includes the retardation plate, a polarizing plate, and an image display cell. In the stereoscopic image display device of another embodiment of the invention, the polarizing plate is placed on the viewer side of the image display cell, and the retardation plate is placed on the viewer side with respect to the polarizing plate. The slow axis direction of the retardation plate makes an angle of 45° with the transmission axis direction of the polarizing plate. The image display cell has first and second image display regions, and the retardation plate is placed so that the first and second retardation regions correspond to the first and second image display regions of the image display cell, respectively.

A further embodiment of the invention is directed to stereoscopic polarizing glasses for stereoscopic view of the stereoscopic image display device. The stereoscopic polarizing glasses of a further embodiment of the invention includes a right eyeglass portion and a left eyeglass portion, and one of the right and left eyeglass portions includes a first circularly polarizing plate, and the other includes a second circularly polarizing plate. The first circularly polarizing plate includes a polarizing plate and a ¼ wave plate having an in-plane retardation of (¼+m)λ at a wavelength λ, and a slow axis direction of the ¼ wave plate makes an angle of 45° with a transmission axis direction of the polarizing plate. The second circularly polarizing plate includes a polarizing plate and a ¾ wave plate having an in-plane retardation of (¾+n)λ at a wavelength λ, and a slow axis direction of the ¾ wave plate makes an angle of 45° with a transmission axis direction of the polarizing plate.

In the stereoscopic polarizing glasses of a further embodiment of the invention, as shown in FIGS. 9 and 10, a sign of the angle between the slow axis direction 711 of the ¼ wave plate 71A and the transmission axis direction 712 of the polarizing plate 71B in the first circularly polarizing plate 71 is preferably the same as a sigh of an angle between the slow axis direction 721 of the ¾ wave plate 72A and the transmission axis direction 722 of the polarizing plate 72B in the second circularly polarizing plate 72. In particular, as shown in FIG. 9, the slow axis direction 711 of the ¼ wave plate 71A in the first circularly polarizing plate 71 is preferably parallel to the slow axis direction 721 of the ¾ wave plate 72A in the second circularly polarizing plate 72.

A further embodiment of the invention is directed to a stereoscopic image display system including a combination of the stereoscopic image display device and the stereoscopic polarizing glasses. Particularly, in the stereoscopic image display system of the invention, the slow axis direction of the ¼ wave plate in the first circularly polarizing plate is preferably parallel to the slow axis direction of the ¾ wave plate in the second circularly polarizing plate, and the stereoscopic image display of the invention is preferably configured so that when the stereoscopic image display is viewed in the normal direction, the slow axis direction of the retardation plate is perpendicular to the slow axis directions of the ¼ and ¾ wave plates in the first and second circularly polarizing plates of the polarizing glasses.

The retardation plate of the invention has first and second retardation regions in the same plane, and the polarizing element including a laminate of the retardation plate of the invention and a polarizing plate can produce circularly polarized light beams with opposite polarities at the first and second retardation regions, respectively, and therefore can be used for forming stereoscopic images. In the retardation plate of the invention, the slow axis directions of the first and second retardation regions are parallel to each other, which makes it possible to easily produce the retardation plate of the invention, for example, by a process including preparing a film having a uniform in-plane retardation and reducing the retardation of the predetermined region(s).

### BRIEF DESCRIPTION OF DRAWINGS

FIG. 1 is a plan view schematically showing a retardation plate according to an embodiment of the invention;

FIG. 2A is a cross-sectional view schematically showing a polarizing element according to an embodiment of the invention;

FIG. 2B is a perspective view schematically showing the configuration of a polarizing element according to an embodiment of the invention;

FIG. 3A is a cross-sectional view schematically showing a stereoscopic image display device according to an embodiment of the invention;

FIG. 3B is a perspective view schematically showing the configuration of a stereoscopic image display device according to an embodiment of the invention;

FIG. 4 is a plan view schematically showing a retardation plate according to an embodiment in which each retardation region has a plurality of sub-regions;

FIG. 5 is a plan view schematically showing a retardation plate according to an embodiment in which each retardation region has a plurality of sub-regions;

FIG. 6 is a cross-sectional view schematically showing a stereoscopic image display device according to an embodiment of the invention;

FIG. 7 is a cross-sectional view schematically showing a stereoscopic image display device according to an embodiment of the invention;

FIG. 8 is a perspective view schematically showing stereoscopic polarizing glasses according to the invention;

FIG. 9 is a perspective view schematically showing the arrangement of circularly polarizing plates that form stereoscopic polarizing glasses according to an embodiment of the invention; and

FIG. 10 is a perspective view schematically showing the arrangement of circularly polarizing plates that form stereoscopic polarizing glasses according to another embodiment of the invention.

### DETAILED DESCRIPTION OF THE PREFERRED EMBODIMENTS

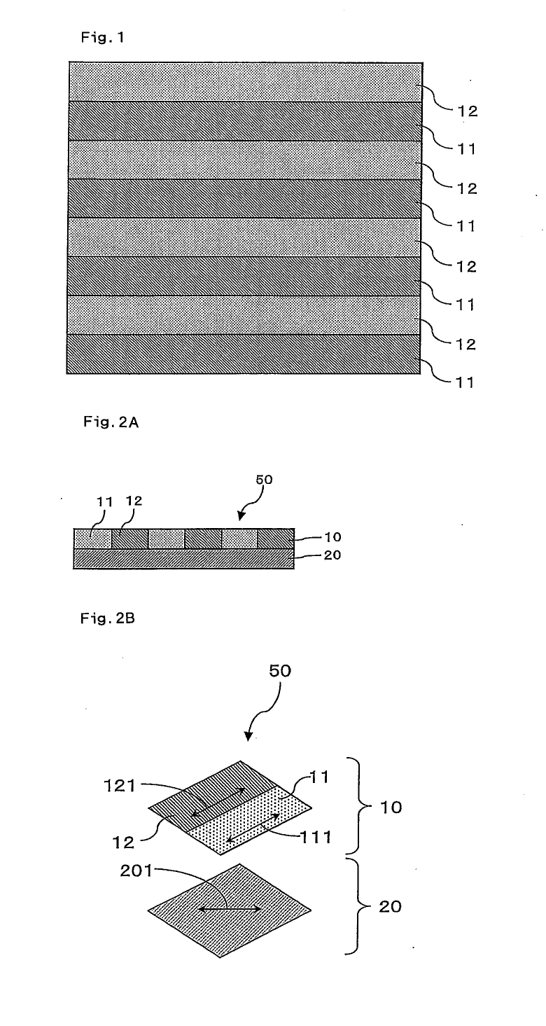

The invention is described below with reference to the drawings. FIG. 1 is a plan view schematically showing a retardation plate according to an embodiment of the invention. The retardation plate 10 has a plurality of first retardation regions 11 and a plurality of second retardation regions 12, wherein the first and second retardation regions 11 and 12 are provided in a plane.

At a visible light wavelength λ, the first retardation regions 11 have an in-plane retardation of (¼+m)λ, and the second retardation regions have an in-plane retardation of (¾+n)λ, wherein m and n each represents 0 or a natural number. For example, when m=n=0, the first retardation regions have an in-plane retardation of ¼ wavelength, and the second retardation regions have an in-plane retardation of ¾ wavelength. The first and second retardation regions have slow axis directions 111 and 121 parallel to each other.

FIG. 2A is a cross-sectional view schematically showing a polarizing element 50 including a laminate of the retardation plate 10 of the invention and a polarizing plate 20, and FIG. 2B is a perspective view schematically showing the polarizing element 50. The polarizing plate 20 has a transmission axis direction 201 with which the slow axis directions 111 and 121 of the retardation plate 10 each make an angle of 45°.

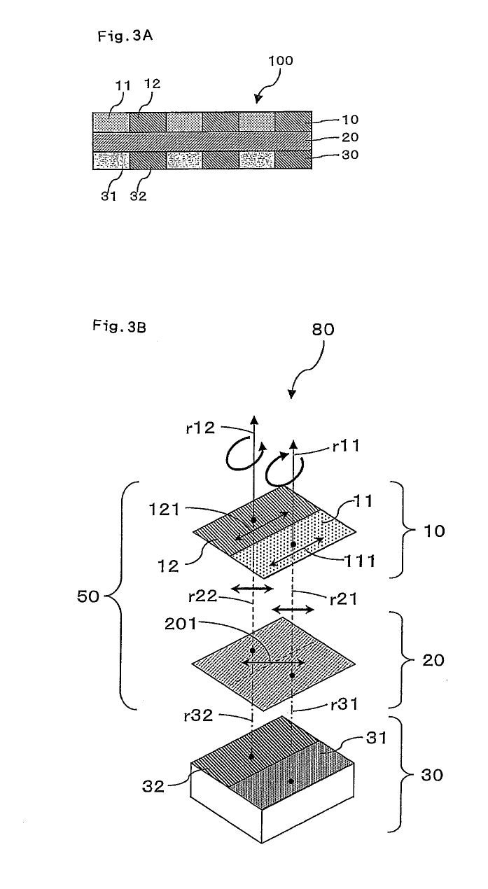

FIG. 3A is a cross-sectional view schematically showing a stereoscopic image display device according to the invention, and FIG. 3B is a perspective view schematically showing the stereoscopic image display device according to the invention. For the sake of simplicity, FIGS. 2B and 3B each show only one first retardation region 11 and one second retardation region, but the actual structure has a plurality of the first retardation regions 11 and a plurality of the second retardation regions 12.

The stereoscopic image display device 80 according to the invention includes an image display cell 30, a polarizing plate 20 placed on the viewer side of the image display cell 30, and the retardation plate 10 placed on the viewer side of the polarizing plate 20. The image display cell 30 has a plurality of first image display regions 31 and a plurality of second image display regions 32, wherein the first and second image display regions 31 and 32 are provided in a plane. As shown in FIG. 3A, the first and second retardation regions 11 and 12 of the retardation plate 10 are arranged to correspond to the first and second image display regions 31 and 32 of the image display cell 30, respectively.

A principle of making stereoscopic image by above structure is described below. Naturally polarized light r31 or light r31 having a predetermined state of polarization is output from the first image display regions 31 of the image display cell. When the light r31 passes through the polarizing plate 20, only a polarized component r21 having vibration in the transmission axis direction 201 of the polarizing plate 20 is transmitted to the retardation plate 10 side, and a polarized component having vibration in a direction perpendicular to the transmission axis direction 201 is blocked.

Light r21 transmitted through the polarizing plate 20 arrives at the first retardation regions 11 of the retardation plate 10. In this process, the vibration direction of the light r21 makes an angle of 45° with the slow axis direction 111 of the retardation plate, and the in-plane retardation Re₁ is (¼+m) times the wavelength λ (when m=0, ¼ times the wavelength). Therefore, light r11 is converted into circularly polarized light after passing through the first retardation regions 11 of the retardation plate 10.

On the other hand, naturally polarized light r32 or light r32 having a predetermined state of polarization is output from the second image display regions 32 of the image display cell. When the light r32 passes through the polarizing plate 20, only a polarized component r22 having vibration in the transmission axis direction 201 of the polarizing plate 20 is transmitted to the retardation plate 10 side, and a polarized component having vibration in a direction perpendicular to the transmission axis direction 201 is blocked.

Light r22 transmitted through the polarizing plate 20 arrives at the second retardation regions 12 of the retardation plate 10. In this process, the vibration direction of the light r22 makes an angle of 45° with the slow axis direction 111 of the retardation plate, and the in-plane retardation Re₂ is (¾+n) times the wavelength λ (when n=0, ¾ times the wavelength). Therefore, light r12 is also converted into circularly polarized light after passing through the second retardation regions 12 of the retardation plate 10.

In the retardation plate 10, the first retardation regions 11 differ in retardation by a half wavelength (or a half wavelength+an integral multiple of the wavelength) from the second retardation regions 12. In other words, the phases of the circularly polarized light r11 and the circularly polarized light r12 after passing through the first and second retardation regions are shifted by n from each other. Therefore, the circularly polarized light r11 and the circularly polarized light r12 are produced having opposite polarities.

For example, an image for the right eye (right-eye image) is output from the first image display regions 31 of the image display cell, and an image for the left eye (left-eye image) is output from the second image display regions 32. In this case, the polarizing plate 20 and the retardation plate 10 function to produce right-handed circularly polarized light r11 for the right-eye image from the first image display regions and also function to produce left-handed circularly polarized light r12 for the left-eye image from the second image display regions. The viewer wears stereoscopic polarizing glasses 70 when viewing the images. For example, the polarizing glasses 70 includes a right eyeglass portion including a first circularly polarizing plate 71 capable of transmitting right-handed circularly polarized light and blocking left-handed circularly polarized light and a left eyeglass portion including a second circularly polarizing plate 72 capable of transmitting left-handed circularly polarized light and blocking right-handed circularly polarized light.

This feature allows the viewer's right eye to see only the right-eye image and the viewer's left eye to see only the left-eye image. Therefore, the difference between the right- and left-eye images, namely, the binocular parallax causes the illusion of depth, so that the viewer recognizes a stereoscopic image.

The invention is more specifically described below with reference to embodiments in which a case where the first and second retardation regions have in-plane retardations Re₁ and Re₂ of λ/4 and 3λ/4, respectively, namely where m=n=0, is mainly shown. It should be noted that similarly to the case where m=n=0, cases where m and/or n is 1 or more can also be carried out by adding an integral multiple of the wavelength to each in-plane retardation.

The retardation plate 10 of the invention includes first retardation regions 11 and second retardation regions 12 in the same plane. When stereoscopic display is achieved using the retardation plate of the invention, the first and second retardation regions correspond to the right-eye and left-eye (or vice versa) display regions of the image display cell, respectively.

FIG. 1 shows an embodiment in which the first and second retardation regions 11 and 12 are arranged in an alternating stripe pattern. Such an embodiment is not intended to limit the scope of the invention, and the first and second retardation regions 11 and 12 may be arranged in any other pattern such as a lattice pattern. When the first and second retardation regions are arranged in a stripe pattern, the width of each stripe line preferably corresponds to the width of each of the right-eye and left-eye image display lines. In such a case, each retardation region preferably has a small width, and more specifically, the width of each retardation region preferably corresponds to the length of one side of the pixel of the image display device (the width of the pixel). When the first and second retardation regions 11 and 12 are arranged in a lattice pattern, each retardation region preferably corresponds to each pixel of the image display device.

The boundary part between the first and second retardation regions sometimes cannot function to image a display. From this point of view, it is preferred that the first and second retardation regions be arranged in an alternating stripe pattern with the area of the boundary part between them kept small.

The first retardation regions have an in-plane retardation Re₁ that is (¼+m) times the wavelength λ, and the second retardation regions have an in-plane retardation Re₂ that is (¾+n) times the wavelength λ, wherein m and n are each 0 or a natural number. In terms of increasing the image color reproducibility or making it easy to produce the retardation plate, m and n are each preferably equal to 0, namely, the in-plane retardations Re₁ and Re₂ of the first and second retardation regions are preferably ¼ and ¾ times the wavelength, respectively.

The in-plane retardation Re₁ of the first retardation regions does not have to be strictly ¼ times the wavelength and may be in a range where linearly polarized light can be converted into substantially circularly polarized light. The term “substantially circularly polarized light” is intended to include not only completely circularly polarized light but also elliptically polarized light that is close to completely circularly polarized light, namely, has an ellipticity close to 1. From this point of view, at a wavelength of 550 nm (λ=550 nm), the first retardation regions preferably have an in-plane retardation Re₁(550) of 137.5±30 nm, more preferably 137.5±20 nm.

The in-plane retardation Re₂ of the second retardation regions also does not have to be strictly ¾ times the wavelength and may be in a range where linearly polarized light can be converted into substantially circularly polarized light. At a wavelength of 550 nm (λ=550 nm), the second retardation regions preferably have an in-plane retardation Re₂(550) of 412.5±90 nm, more preferably 412.5±60 nm.

The slow axis direction 111 of the first retardation regions is parallel to the slow axis direction 121 of the second retardation regions. When the slow axis directions of the first and second retardation regions are parallel to each other, the retardation plate having the first and second retardation regions with different retardations in the same plane can be easily produced by a process of using a printer or any other means to locally reduce the retardation as described below. The term “parallel” means not only that the angle between them is strictly 0° but also that the angle between them is in a range where the objects of the invention can be achieved, typically in the range of 0±5°, preferably in the range of 0±3°.

For example, the retardation plate having two retardation regions with different retardations and slow axis directions parallel to each other in the same plane may be produced by a non-limiting method including the steps of producing a film having a uniform in-plane retardation and then reducing the retardation of at least one of first and second regions.

The film having a uniform in-plane retardation (hereinafter referred to as the “uniform retardation plate”) may be typically formed by a method including stretching a polymer film to impart molecular orientation to the film or by a method of forming a molecularly oriented film on a base material. Alternatively, a commercially available retardation plate or the like may be used.

The polymer film stretching method to impart molecular orientation may be performed by any appropriate stretching process such as uniaxial stretching or biaxial stretching. In view of controlling retardation and the like, a stretched film having a highly uniform retardation in which the molecule is oriented as uniformly as possible is preferably used.

The method of forming an alignment film of molecules on a base material may be a method of orienting a polymerizable liquid crystal material or the like on a base film. A transparent film having an orientation regulating force is preferably used as the base material. Examples of methods for allowing a transparent film to have an orientation regulating force include a method of rubbing the surface of a base material, a method including forming an alignment film of polyimide or the like on a base material and rubbing the surface of the alignment film, and a method including forming, on a base material, a film of a compound capable of undergoing photo-isomerization, photo-dimerization, or photo-reaction such as photolysis and applying light to the film to form a photo-alignment film having a certain orientation.

The uniform retardation plate obtained as described above has an in-plane retardation Re₀ equal to or greater than the retardation Re₁ of the first retardation region of the desired retardation plate and equal to or greater than the retardation Re₂ of the second retardation region of the desired retardation plate. Specifically, when Re₁=λ/4 and Re₂=3λ/4, Re₀ is equal to or greater than 3λ/4. When the uniform retardation plate has an in-plane retardation in such a range, the retardation plate of the invention having the first and second retardation regions can be manufactured through the process of reducing the retardation. In this connection, the in-plane retardation of the uniform retardation plate may have in-plane variations of several nm due to manufacturing tolerances and other causes.

The process of reducing the retardation includes reducing the retardation of at least one of first and second regions of the uniform retardation plate. The first and second regions of the uniform retardation plate correspond to the first and second retardation regions 11 and 12 of the retardation plate 10, respectively.

In the process of reducing the retardation, only one of the first and second regions may be reduced in retardation, or both of the first and second regions may be reduced in retardation. When both of the first and second regions are reduced in retardation, both regions are reduced in retardation by different amounts so that the first and second retardation regions can be formed.

For example, a uniform retardation plate with an in-plane retardation Re₀ of 3λ/4 may be used, and only the first regions may be reduced in retardation, so that a retardation plate with an Re₁ of λ/4 and an Re₂ of 3λ/4 can be obtained. Alternatively, a uniform retardation plate with an in-plane retardation Re₀ of more than 3λ/4 may be used, and the first regions may be reduced in retardation by an amount λ/2 more than the second regions, so that a retardation plate with an Re₁ of λ/4 and an Re₂ of 3λ/4 can also be obtained.

The case described above where the retardation plate 10 has first retardation regions 11 with an in-plane retardation Re₁ of λ/4 and second retardation regions 12 with an in-plane retardation Re₂ of 3λ/4 can be generalized to the case where the retardation plate has first retardation regions with an in-plane retardation Re₁ of (¼+m)λ and second retardation regions with an in-plane retardation Re₂ of (¾+n)λ by setting, to (½+p)λ, the absolute value of the difference between the amounts of reduction in the retardation of the first and second regions, wherein p is 0 or a natural number, preferably 0.

In the process of reducing the retardation, the retardation should be reduced without changing the slow axis direction of the uniform retardation plate. In such a process, the retardation is preferably reduced by reducing the degree of the molecular orientation in the film. For example, the degree of the molecular orientation may be reduced by a method of heating the film to at least the glass transition temperature (heat distortion temperature) or by a method of applying, to the film, a liquid chemical capable of allowing the film to dissolve or swell. The heating method or the liquid chemical application method may be any appropriate method such as a heating method using a heat source or an electric discharge or a method of applying an organic solvent or any other material capable of allowing the film to dissolve or swell. The application of heat may also be used in combination with the application of a liquid chemical.

In order to pattern the first and second retardation regions into fine regions, the application of heat or a liquid chemical is preferably performed using an appropriate thermal-type or liquid chemical jet-type printer such as a thermal transfer printer or an inkjet printer. A laser-beam heating method, a press heating method such as stamping, or a liquid chemical application method based on masking, printing or the like may also be used to reduce the retardation of the predetermined regions so that patterned first and second retardation regions can be efficiently formed.

The side of the retardation plate 10 where the polarizing plate 20 is not placed, namely, the viewer side of the retardation plate 10 may undergo a hard coating treatment, an antireflection treatment, an anti-sticking treatment, or a diffusion or antiglare treatment. The antireflection layer, anti-sticking layer, diffusion layer, antiglare layer, or the like may be formed as part of the retardation plate or as an optical layer independent of the retardation plate.

In general, the in-plane retardation of the retardation plate varies with wavelength. Such a property is also called the “wavelength dispersion” of the retardation. The wavelength dispersion property is a value specific to the material of the retardation plate, and general polymers often have smaller retardations at longer wavelengths. Due to the effect of the wavelength dispersion, therefore, a retardation plate with a retardation of λ₁/4 at a wavelength λ₁ can have a retardation deviating from λ₂/4 at a wavelength λ₂, so that an image display device can output a light beam with a deviation from circular polarization at the wavelength λ₂. At a wavelength where an image display device outputs a light beam with a relatively large deviation from circularly polarization, part of the light beam to be viewed by the right eye for the right-eye image can be viewed by the left eye rather than the right eye, and part of the light beam to be viewed by the left eye for the left-eye image can be viewed by the right eye, so that the color reproducibility of the stereoscopic image can be reduced, or the stereoscopic image can be blurred.

In an embodiment of the invention, to prevent such a reduction in color reproducibility or such stereoscopic image blurring, the first and second retardation regions of the retardation plate preferably has such a wavelength dispersion property that they can convert linearly polarized light into circularly polarized light in a wide visible light range. More specifically, the first and second retardation regions preferably have in-plane retardations that increase with increasing wavelength (greater in-plane retardations at a longer wavelength). In particular, if the first and second retardation regions have in-plane retardations of Re₁(λ) and Re₂(λ), respectively, at a wavelength of λ nm, Re₁(450)/Re₁(550) and Re₂(450)/Re₂(550) are each most preferably 0.82 in theory. In general, when Re₁(450)/Re₁(550) is from about 0.80 to about 0.99, the wavelength dispersion will be in a range where it can be easily controlled by the type of the polymer that forms the retardation film or other factors, and to achieve both easy manufacture of the retardation plate and high quality of stereoscopic images at the same time, Re₁(450)/Re₁(550) and Re₂(450)/Re₂(550) are each preferably from 0.85 to 0.95, more preferably from 0.85 to 0.90.

The wavelength dispersion property is a material-specific value. In general, therefore, the wavelength dispersion of the first retardation region is substantially equal to that of the second retardation region. In order to set the wavelength dispersion in the above range, the material used to form the retardation plate is preferably a polymer capable of producing a greater retardation at a longer wavelength, such as a cellulose derivative having a specific degree of substitution as disclosed in JP-A No. 2000-137116, the copolymerized polycarbonate disclosed in International Publication No. WO00/26705, or the polyvinyl acetal-based polymer disclosed in JP-A Nos. 2006-171235 and 2006-89696.

A method of dividing each retardation region of the retardation plate 10 into sub-regions may also be used to prevent a reduction in color reproducibility or stereoscopic image blurring regardless of the wavelength dispersion of the retardation of the retardation plate. Generally, in an image display device, a plurality of subpixels having different main output wavelengths is used as one pixel to display an image. In an embodiment of the invention, the first retardation region of the retardation plate has sub-regions each of which has an in-plane retardation of λₖ/4 at a main wavelength λₖ of light output from each corresponding subpixel of the image display cell, and the second retardation region has sub-regions each of which has an in-plane retardation of 3λₖ/4 at a main wavelength λₖ of light output from each corresponding subpixel of the image display cell.

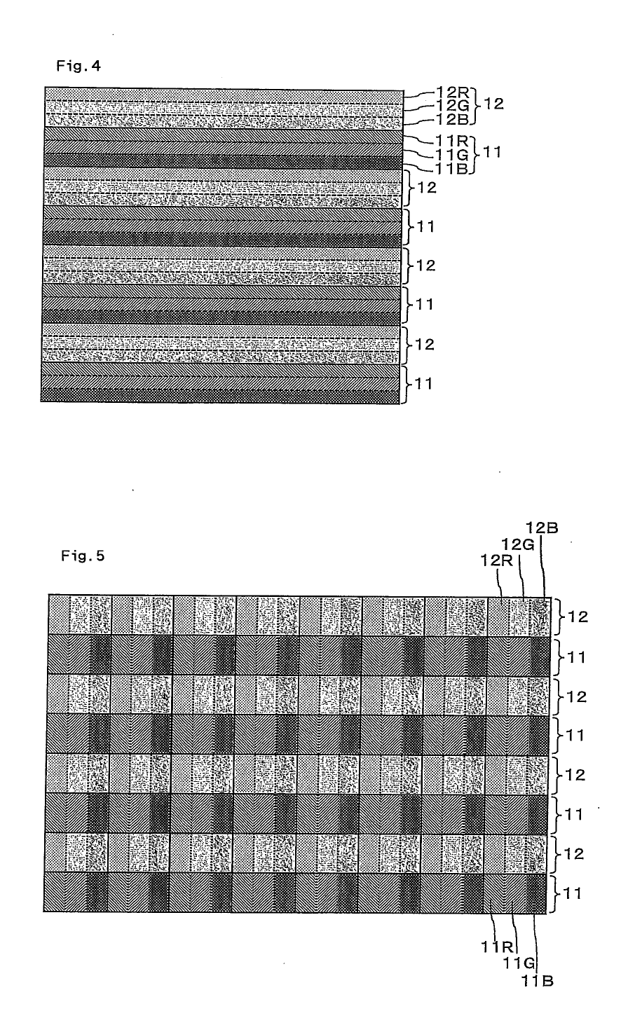

A stereoscopic image display device can be formed by incorporating the retardation plate 10 into a liquid crystal display including a red color filter (R) with a transmission center wavelength of 650 nm, a green color filter (G) with a transmission center wavelength of 550 nm, and a blue color filter (B) with a transmission center wavelength of 440 nm, wherein three RGB subpixels are used as one pixel to display an image. This case is described below as an example. As shown in FIG. 4, the first retardation region 11 has a sub-region 11R corresponding to the red subpixel, a sub-region 11G corresponding to the green subpixel, and a sub-region 11B corresponding to the blue subpixel. The second retardation region 12 has a sub-region 12R corresponding to the red subpixel, a sub-region 12G corresponding to the green subpixel, and a sub-region 12B corresponding to the blue subpixel.

The in-plane retardations of the sub-regions 11R, 11G, and 11B are ¼ times the transmission center wavelengths of the red color filter (R), green color filter (G), and blue color filter (B), respectively, which are therefore 162.5 nm, 138.5 nm, and 110 nm, respectively. The in-plane retardations of the sub-regions 12R, 12G, and 12B are ¾ times the transmission center wavelengths of the red color filter (R), green color filter (G), and blue color filter (B), respectively, which are therefore 487.5 nm, 412.5 nm, and 330 nm, respectively. The in-plane retardation of each sub-region does not have to be strictly equal to the above value and may be in a range where linearly polarized light can be converted into substantially circularly polarized light, typically in the range of the in-plane retardation ±20 nm, preferably in the range of the in-plane retardation ±10 nm.

When each retardation region has a plurality of sub-regions each of which has an in-plane retardation of ¼ or ¾ of the transmission center wavelength of each subpixel as described above, the light of the main wavelength output from each subpixel can be converted into circularly polarized light. This structure can prevent a reduction in color reproducibility or stereoscopic image blurring regardless of the wavelength dispersion property of the retardation of the retardation plate.

FIG. 4 shows an embodiment in which the respective sub-regions are arranged in a stripe pattern. It is understood that the embodiment is not intended to limit the scope of the invention, and, for example as shown in FIG. 5, one retardation region may have a plurality of sub-regions arranged in a repeated pattern. In the liquid crystal display, the in-plane retardation of each sub-region should be set to ¼ or ¾ of the transmission center wavelength of the color filter. On the other hand, in a self-luminous display device such as an organic EL display device, a plasma display device, or a cathode ray tube, the in-plane retardation of each sub-region should be set to ¼ or ¾ of the predominant wavelength of the light emitted from each subpixel.

Next, a description is given of the polarizing element of the invention. As shown in FIGS. 2A and 2B schematically, the polarizing element 50 of the invention has a structure including a laminate of the retardation plate 10 and a polarizing plate 20. The transmission axis direction 201 of the polarizing plate 20 makes an angle of 45° with the slow axis direction 111 and 121 of the retardation plate 10. In this structure, linearly polarized light transmitted through the polarizing plate 20 is converted, by the retardation plate 10, into circularly polarized light having opposite polarities at the first and second regions.

In the description, the value “45°” indicates not only that the angle is strictly 45° but also that the angle only has to be in a range where linearly polarized light can be converted into substantially circularly polarized light, typically in the range of 45±5°, preferably in the range of 45±3°. Unless otherwise stated, the sign of the angle is not restricted, and the angle may be counterclockwise (+) or clockwise (−).

The polarizing plate 20 to be used may be of any type that can convert light in any state of polarization into linearly polarized light. The polarizing plate to be used typically includes a polarizer and a transparent protective film(s) that is placed on one or both main surfaces of the polarizer as needed. For example, the polarizer may be a product produced by the steps of adsorbing a dichroic material such as iodine or a dichroic dye to a hydrophilic polymer film such as a polyvinyl alcohol film, a partially-formalized polyvinyl alcohol film, or a partially-saponified ethylene-vinyl acetate copolymer film and uniaxially stretching the film or may be a polyene-based oriented film such as a dehydration product of polyvinyl alcohol or a dehydrochlorination product of polyvinyl chloride. Examples of polarizers that may be used also include an O-type, guest-host polarizer as disclosed in U.S. Pat. No. 5,523,863 in which a liquid crystalline composition containing a dichroic substance and a liquid crystalline compound is oriented in a certain direction, and an E-type polarizer as disclosed in U.S. Pat. No. 6,049,428 in which a lyotropic liquid crystal is oriented in a certain direction.

A film having a high level of transparency, mechanical strength, thermal stability, water-blocking performance, isotropy, and the like is preferably used as the transparent protective film placed on one or both main surfaces of the polarizer preferably. The retardation plate of the invention may also be placed on the polarizing plate to function as both a polarizing plate-protecting film and a retardation plate for stereoscopic image display.

In the process of forming the polarizing element, the polarizing plate 20 and the retardation plate 10 may be only placed on each other or bonded together with an adhesive or any other material interposed therebetween. A polarizing plate-protecting film or any other film, a glass substrate for forming an image display cell, or any other material may also be interposed between the polarizing plate 20 and the retardation plate 10.

A stereoscopic image display device is formed by placing the retardation plate 10 of the invention or the polarizing element 50 of the invention on the viewer side of an image display cell 30. The expression “the viewer side of an image display cell” means not only that the placement is on the viewer side with respect to all the components of the image display cell but also that the placement may be on the viewer side, for example, with respect to the liquid crystal layer of a liquid crystal cell, which means that the placement does not always have to be on the viewer side with respect to the viewer side glass substrate of the liquid crystal cell.

As shown in FIG. 3A, the retardation plate 10 of the invention is placed on the viewer side with respect to the polarizing plate 20. The first and second retardation regions 11 and 12 of the retardation plate are placed on the viewer side in the normal direction of the screen so as to correspond to the first and second image display regions 31 and 32 of the image display cell 30, respectively. One of the first and second image display regions 31 and 32 corresponds to the right-eye image display region, and the other corresponds to the left-eye image display region. In this structure, light output from the first and second image display regions of the image display cell is converted into circularly polarized output light with opposite polarities by the polarizing plate 20 and the retardation plate 10, so that stereoscopic display is achieved.

The image display cell 30 may be of any type. For example, the image display cell 30 to be used may be a self-luminous display cell such as an organic EL cell, a plasma display cell, or a cathode ray tube, or a display cell configured to control the amount of transmission of light from a light source, such as a liquid crystal cell. The screen of a projection-type display device such as a rear projection system may also be used.

In particular, a liquid crystal display, in which a polarizing plate is placed on the viewer side of a liquid crystal cell for image display, can form a stereoscopic image display device with no additional polarizing plate, when the retardation plate of the invention is added thereto. Optionally, another polarizing plate may be provided in addition to the polarizing plate on the viewer side. In an organic EL display device, a circularly polarizing plate including a laminate of a ¼ wave plate and a polarizing plate is sometimes placed on the viewer side of the organic light-emitting layer so that specular reflection of external light by the metal electrode can be blocked. Therefore, a stereoscopic image display device may be formed by placing the retardation plate of the invention on the viewer side of the circularly polarizing plate in the organic EL display.

A description is given of a liquid crystal display device having a liquid crystal cell to be used as the image display cell 30 for the stereoscopic image display device. The liquid crystal cell to be used may be any one of a reflective liquid crystal cell that operates using external light, a transmissive liquid crystal cell that operates using light from a light source such as a backlight, and a transflective liquid crystal cell that operates using both external light and light from a light source. Any type of driving mode such as VA mode, IPS mode, TN mode, STN mode, or bend alignment (n) mode may be used for the liquid crystal cell.

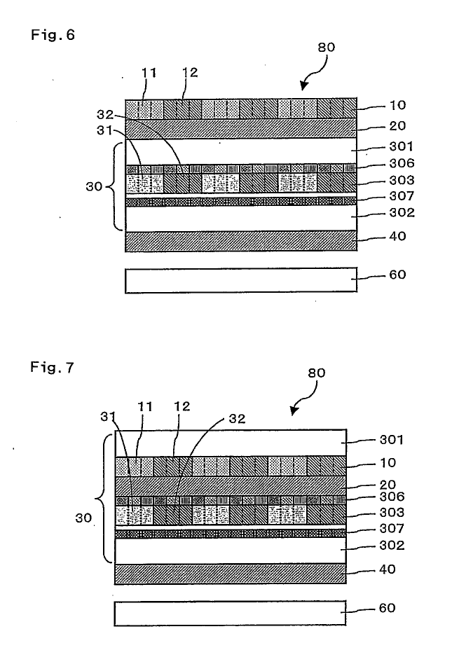

Referring to FIG. 6, the liquid crystal cell 30 includes a pair of substrates 301 and 302 and a liquid crystal layer 303 interposed therebetween as a display medium. In a general structure, color filter layers 306 are provided on one substrate 301, and the other substrate 302 is provided with switching elements 307 for controlling the electro-optical properties of the liquid crystal, scanning and signal lines for applying gate and source signals to the switching elements, respectively, and pixel and counter electrodes. The distance (cell gap) between the substrates 301 and 302 can be controlled using spacers or the like. For example, a polyimide alignment film or any other alignment film may be provided on the substrate side in contact with the liquid crystal layer 303. For example, the color filter layers 306 have color filters for each of red (R), green (G), and blue (B) colors and a black matrix.

The polarizing plate 20 and the retardation plate 10 are placed on the viewer side substrate 301. The retardation plate 10 is placed so that the first and second retardation regions 11 and 12 correspond to the first and second image display regions 31 and 32 of the image display cell 30, respectively. When the first and second retardation regions 11 and 12 of the retardation plate 10 are each divided into a plurality of sub-regions with different in-plane retardations as shown in FIG. 4 or 5, each sub-region is placed to correspond to each subpixel of the image display device.

The slow axis direction of the retardation plate 10 makes an angle of 45° with the transmission axis direction of the polarizing plate 20. The retardation plate 10 and the polarizing plate 20 are preferably bonded to the substrate 301 of the liquid crystal cell with a pressure-sensitive adhesive or an adhesive or the like interposed therebetween. When a transmissive liquid crystal cell or a transflective liquid crystal cell is used as the liquid crystal cell 30, a polarizing plate 40 and a light source 60 are preferably placed on the substrate 302 side of the liquid crystal cell.

Alternatively, as shown in FIG. 7, the polarizing plate 20 and the retardation plate 10 may be placed inside the glass substrate 301 that forms the liquid crystal cell 30 (on the liquid crystal layer 303 side). In this embodiment, the retardation plate 10 can be placed in the process of forming the liquid crystal cell, and therefore, the image display regions 31 and 32 of the liquid crystal cell 30 can be easily aligned with the retardation regions 11 and 12 of the retardation plate 10. In this embodiment, the distance between the retardation plate 10 and the liquid crystal layer 303 in which the pixels of the liquid crystal cell are formed is also small, so that the correspondence relationship between each image display region of the liquid crystal cell and each retardation region of the retardation plate can be maintained even when the image display device is obliquely viewed, which makes it possible to suppress mixing of (crosstalk between) the right-eye image and the left-eye image.

In FIG. 7, the polarizing plate 20 and the retardation plate 10 are provided on the viewer side (substrate 301 side) of the color filter layers 306. Alternatively, however, the color filter layers 306 may be placed between the polarizing plate 20 and the retardation plate 10 or between the retardation plate 10 and the substrate 301.

Also when any other cell than the liquid crystal cell, such as an organic EL cell, a plasma display cell, or a cathode ray tube is used as the image display cell, the first and second retardation regions 11 and 12 of the retardation plate 10 may be placed to correspond to the first and second image display regions 31 and 32 of the image display cell 30, respectively, to form a stereoscopic image display device.

When viewing the stereoscopic image output from the stereoscopic image display device of the invention, the viewer wears stereoscopic polarizing glasses including two pieces of circularly polarizing plates with opposite polarities as right and left eyeglass portions, so that the viewer perceives the stereoscopic image.

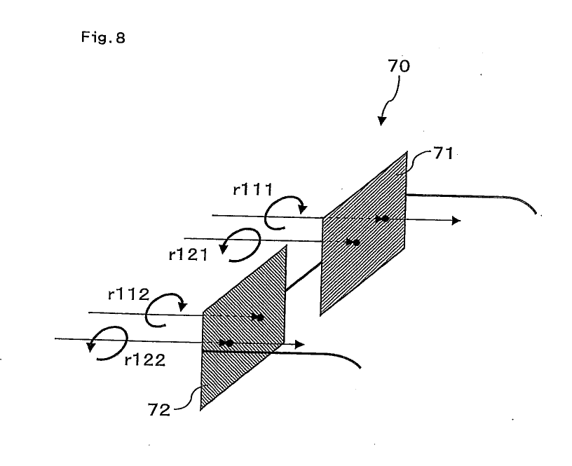

The stereoscopic polarizing glasses 70 include a first circularly polarizing plate 71 as one of right and left eyeglass portions and a second circularly polarizing plate 72 as the other. As shown schematically in FIG. 8, the first circularly polarizing plate 71 transmits first circularly polarized light r111, which is produced after passing through the first retardation region 11 from the first image display region 31, and blocks second circularly polarized light r121, which is produced after passing through the second retardation region 12 from the second image display region 32. On the other hand, the second circularly polarizing plate 72 blocks first circularly polarized light r112, which is produced after passing through the first retardation region 11 from the first image display region 31, and transmits second circularly polarized light r122, which is produced after passing through the second retardation region 12 from the second image display region 32. The first circularly polarized light and the second circularly polarized light have opposite polarities. Specifically, one of the first circularly polarized light and the second circularly polarized light is right-handed circularly polarized light, and the other is left-handed circularly polarized light.

FIGS. 8 to 10 show that the first circularly polarizing plate transmits the first circularly polarized light r111, while the second circularly polarizing plate blocks the first circularly polarized light r112. Alternatively, the direction of the arrangement of the circularly polarizing plates may be controlled so that the first circularly polarizing plate can block the first circularly polarized light r111, while the second circularly polarizing plate can transmit the first circularly polarized light r112.

The first and second circularly polarizing plate 71 and 72 to be used may be a combination of two circularly polarizing plates capable of transmitting circularly polarized light beams with opposite polarities, respectively. Examples of such a combination of two circularly polarizing plates that may be used include a combination of first and second reflective circularly polarizing plates; a combination of a first circularly polarizing plate including a laminate of a polarizing plate and a ¼ wave plate and a second circularly polarizing plate including a laminate of a polarizing plate and a ¾ wave plate; and a combination of a first circularly polarizing plate including a laminate of a polarizing plate and a ¼ wave plate and a second circularly polarizing plate including a laminate of a polarizing plate and a ¼ wave plate in which the arrangement of their axes is in mirror-image relationship with that in the first circularly polarizing plate.

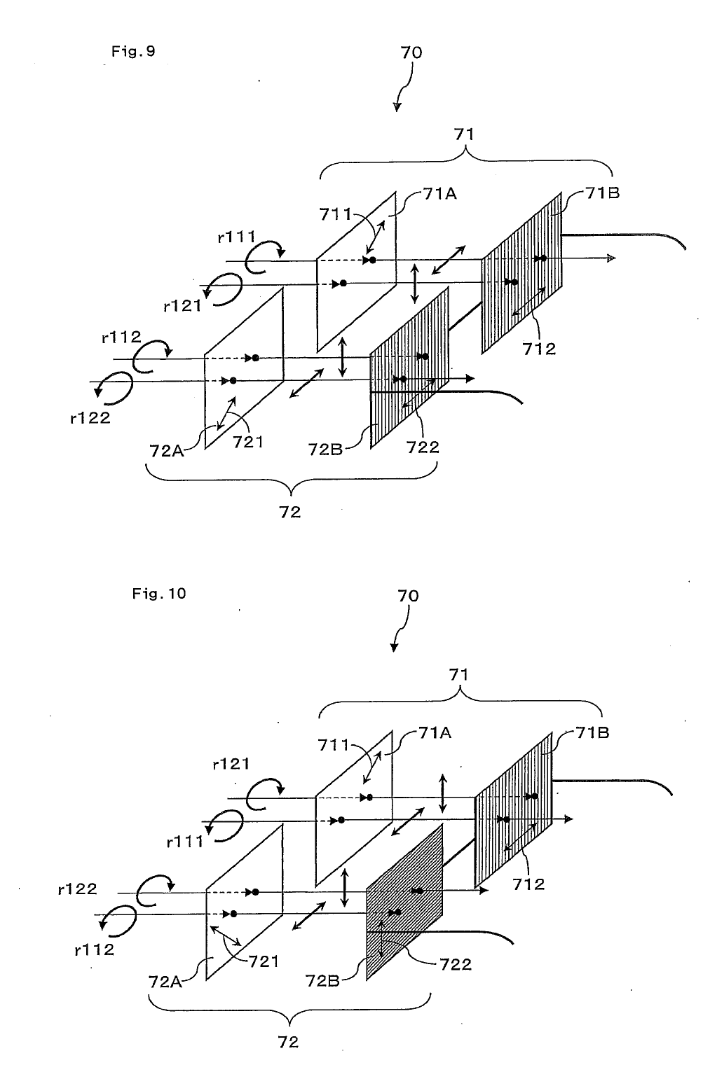

In particular, as shown in FIGS. 9 and 10, a combination of: a first polarizing plate 71 that is a circularly polarizing plate including a laminate of a circularly polarizing plate 71B and a ¼ wave plate 71A; and a second polarizing plate 72 that is a circularly polarizing plate including a laminate of a polarizing plate 72B and a ¾ wave plate 72A is preferably used to form stereoscopic polarizing glasses for use with the stereoscopic image display device of the invention. In such an embodiment, the slow axis direction 711 of the ¼ wave plate 71A in the first circularly polarizing plate 71 makes an angle of 45° with the transmission axis direction 712 of the polarizing plate 71B, and the slow axis direction 721 of the ¼ wave plate 72A in the second circularly polarizing plate 72 also makes an angle of 45° with the transmission axis direction 722 of the polarizing plate 72B. A sign of the angle between the slow axis direction 711 and the transmission axis direction 712 is the same as that between the slow axis direction 721 and the transmission axis direction 722. Therefore, provided that positive (+) angle is defined as counterclockwise, as viewed from the viewer side, when the angle between the slow axis direction 711 and the transmission axis direction 712 is +45°, the angle between the slow axis direction 721 and the transmission axis direction 722 is also +45°, and when the angle between the slow axis direction 711 and the transmission axis direction 712 is −45°, the angle between the slow axis direction 721 and the transmission axis direction 722 is also −45°.

The transmission axis direction 712 of the polarizing plate 71B in the first circularly polarizing plate 71 and the transmission axis direction 722 of the polarizing plate 72B in the second circularly polarizing plate 72 may be parallel to each other or perpendicular to each other as shown in FIG. 10, or make a predetermined angle with each other.

As described above, a combination of a ¼ wave plate and a ¾ wave plate may be used for the two circularly polarizing plates to form the right and left eyeglass portions of the polarizing glasses. In this case, such a combination of in-plane retardations is the same as the combination of the in-plane retardations of the first and second retardation regions of the retardation plate 10. Therefore, the deviation of the in-plane retardation of the first retardation region 11 of the retardation plate 10 from λ/4 at a wavelength λ can be made equal to the deviation of the in-plane retardation of the ¼ wave plate of the first circularly polarizing plate 71 from λ/4. Similarly, the deviation of the in-plane retardation of the second retardation region 12 of the retardation plate 10 from 3λ/4 at a wavelength λ can be made equal to the deviation of the in-plane retardation of the ¾ wave plate 72A of the second circularly polarizing plate 72 from 3λ/4. Thus, the ¼ wave plate 71A and the ¾ wave plate 72B of the polarizing glasses can cancel the deviation from circular polarization, which is caused by the wavelength dispersion in the retardation plate 10, so that a reduction in color reproducibility can be prevented.

In order to prevent a reduction in color reproducibility, the difference is preferably small between the wavelength dispersion of the in-plane retardation of the retardation plate 10 in the stereoscopic image display device and the wavelength dispersion of the retardation of the retardation plates 71A and 72A that form the circularly polarizing plates 71 and 72 of the polarizing glasses. For example, a method of reducing the difference between the wavelength dispersions may include forming the retardation plate 10 and the retardation plates 71A and 72A with the same material.

In order to prevent crosstalk or a reduction in color reproducibility, the polarizing glasses are preferably formed so that the transmission axis direction 712 of the polarizing plate 71B is parallel to the transmission axis direction 722 of the polarizing plate 72B as shown in FIG. 9. The angle between the transmission axis direction 201 of the polarizing plate 20 placed on the viewer side of the stereoscopic image display device and the transmission axis direction 712 or 722 of the polarizing plate in the circularly polarizing plate of the polarizing glasses may be appropriately determined so that a high level of stereoscopic display characteristics can be obtained, depending on the wavelength dispersion property of the in-plane retardation of the retardation plates 10, 71A, and 72A.

In an example of such a configuration, the transmission axis direction 201 of the polarizing plate 20 placed on the viewer side of the stereoscopic image display device is parallel to the transmission axis direction 712 or 722 of the polarizing plate in the circularly polarizing plate of the polarizing glasses, and the slow axis direction 111 or 121 of the retardation plate 10 in the stereoscopic image display device is perpendicular to the slow axis direction 711 or 721 of the retardation plate in the circularly polarizing plate of the polarizing glasses. In such a configuration, when the stereoscopic image display device is viewed in the normal direction, the in-plane retardation of the first retardation region 11 of the retardation plate 10 and the in-plane retardation of the ¼ wave plate 71A in the first circularly polarizing plate of the polarizing glasses cancel each other, and the in-plane retardation of the second retardation region 12 of the retardation plate 10 and the in-plane retardation of the ¾ wave plate 72A in the second circularly polarizing plate of the polarizing glasses cancel each other. Thus, the light from the first image display region 31 is not absorbed by the first polarizing plate 71 of the polarizing glasses 70, and the light from the second image display region 32 is not absorbed by the second polarizing plate 72 of the polarizing glasses 70, so that high color reproducibility is achieved and that a reduction in screen brightness is prevented.

Other angular configurations than those illustrated above may also be used, such as configurations in which the transmission axis direction 201 of the polarizing plate 20 and the transmission axis direction 712 or 722 of the polarizing plate 71B or 72B are perpendicular to each other or neither parallel nor perpendicular to each other. Such angular configurations may be appropriately designed to prevent yellowing in white image or bluing in black image, as long as the first and second circularly polarizing plates 71 and 72 are configured to transmit circularly polarized light beams with opposite polarities.

The polarizing glasses 70 may also be used with any other stereoscopic image display device than that of the invention to produce circularly polarized light beams with opposite polarities for stereoscopic view. In a preferred embodiment, the stereoscopic image display device 80 including the image display cell 30 and the retardation plate 10 of the present invention placed on the viewer side of the image display cell 30 may be used in combination with the stereoscopic polarizing glasses 70 to form a stereoscopic image display system.

What is claimed is:

1. A retardation plate for forming a stereoscopic image, comprising:
a plurality of first retardation regions; and a plurality of second retardation regions,
the first and second retardation regions being provided in a plane, wherein
the first retardation regions have an in-plane retardation of (¼+m)λ at a wavelength λ,
the second retardation regions have an in-plane retardation of (¾+n)λ at a wavelength λ, m and n each being 0 or a natural number, and
the first and second retardation regions have slow axis directions parallel to each other.

2. The retardation plate for forming a stereoscopic image according to claim 1, wherein the first retardation regions have an in-plane retardation of λ/4 at a wavelength λ, and the second retardation regions have an in-plane retardation of 3λ/4 at a wavelength λ.

3. The retardation plate for forming a stereoscopic image according to claim 1, wherein both of the first and second retardation regions have in-plane retardations that increase with increasing wavelength in a visible light range.

4. The retardation plate for forming a stereoscopic image according to claim 1, wherein
the first and second retardation regions each comprise a plurality of sub-regions,
each sub-region of the first retardation region has an in-plane retardation of (¼+m)λₖ at a main wavelength λₖ of light output from each subpixel of an image display device, and
each sub-region of the second retardation region has an in-plane retardation of (¾+n)λₖ at a main wavelength λₖ of light output from each subpixel of the image display device.

5. The retardation plate for forming a stereoscopic image according to claim 1, wherein the first and second retardation regions are arranged in a stripe pattern.

6. A method for producing the retardation plate according to claims 1, comprising:
a first step of producing a film having a uniform in-plane retardation; and
a second step of reducing the retardation of at least one of first and second regions corresponding to the first and second retardation regions, respectively, wherein
in the first step, a film having an in-plane retardation equal to or more than (¼+m)λ and equal to or more than (¾+n)λ is obtained, and
in the second step, the absolute value of the difference between the amounts of reduction in the retardation of the first and second regions is (½+p)λ, wherein p is 0 or a natural number.

7. The method according to claim 6, wherein in the second step, the retardation of only one of the first and second regions is reduced.

8. The method according to claim 6, wherein in the second step, a molecular orientation degree is reduced so that the retardation of the region is reduced.

9. The method according to claim 8, wherein the molecular orientation degree is reduced by locally applying heat.

10. The method according to claim 8, wherein the molecular orientation degree is reduced by applying a liquid chemical capable of allowing the film obtained in the first step to dissolve or swell.

11. A polarizing element, comprising:
a laminate of a polarizing plate and the retardation plate according to claim 1, wherein a slow axis direction of the retardation plate makes an angle of 45° with a transmission axis direction of the polarizing plate.

12. A stereoscopic image display device, comprising:
the retardation plate according to claim 1;
a polarizing plate; and
an image display cell, wherein
the polarizing plate is placed on a viewer side of the image display cell,
the retardation plate is placed on a viewer side with respect to the polarizing plate,
a slow axis direction of the retardation plate makes an angle of 45° with a transmission axis direction of the polarizing plate,
the image display cell has first and second image display regions, and
the retardation plate is placed so that the first and second retardation regions correspond to the first and second image display regions of the image display cell, respectively.

13. Stereoscopic polarizing glasses for stereoscopic view of the stereoscopic image display device of claim 12, comprising: a right eyeglass portion; and a left eyeglass portion, wherein
one of the right and left eyeglass portions comprises a first circularly polarizing plate, the other comprises a second circularly polarizing plate,
the first circularly polarizing plate comprises a polarizing plate and a ¼ wave plate having an in-plane retardation of (¼+m)λ at a wavelength λ, wherein a slow axis direction of the ¼ wave plate makes an angle of 45° with a transmission axis direction of the polarizing plate,
the second circularly polarizing plate comprises a polarizing plate and a ¾ wave plate having an in-plane retardation of (¾+n)λ at a wavelength λ, wherein a slow axis direction of the ¾ wave plate makes an angle of 45° with a transmission axis direction of the polarizing plate,
both of the first and second circularly polarizing plates have the polarizing plate on a viewer side and having the retardation plate on a stereoscopic image display side, and
a sigh of an angle between the slow axis direction of the ¼ wave plate and the transmission axis direction of the polarizing plate in the first circularly polarizing plate is the same as a sign of an angle between the slow axis direction of the ¾ wave plate and the transmission axis direction of the polarizing plate in the second circularly polarizing plate.

14. The stereoscopic polarizing glasses according to claim 13, wherein the slow axis direction of the ¼ wave plate in the first circularly polarizing plate is parallel to the slow axis direction of the ¾ wave plate in the second circularly polarizing plate.

15. A stereoscopic image display system, comprising:
the stereoscopic image display device of claim 12; and a stereoscopic polarizing glasses, the polarizing glasses comprising a right eyeglass portion and a left eyeglass portion, wherein
one of the right and left eyeglass portions comprises a first circularly polarizing plate, the other comprises a second circularly polarizing plate,
the first circularly polarizing plate comprises a polarizing plate and a ¼ wave plate having an in-plane retardation of (¼+m)λ at a wavelength λ, wherein a slow axis direction of the ¼ wave plate makes an angle of 45° with a transmission axis direction of the polarizing plate,
the second circularly polarizing plate comprises a polarizing plate and a ¾ wave plate having an in-plane retardation of (¾+n)λ at a wavelength λ, wherein a slow axis direction of the ¾ wave plate makes an angle of 45° with a transmission axis direction of the polarizing plate,
both of the first and second circularly polarizing plates have the polarizing plate on a viewer side and having the retardation plate on a stereoscopic image display side, and
a sign of an angle between the slow axis direction of the ¼ wave plate and the transmission axis direction of the polarizing plate in the first circularly polarizing plate is the same as a sign of an angle between the slow axis direction of the ¾ wave plate and the transmission axis direction of the polarizing plate in the second circularly polarizing plate.

16. The stereoscopic image display system according to claim 15, wherein
the stereoscopic polarizing glasses are configured so that the slow axis direction of the ¼ wave plate in the first circularly polarizing plate is parallel to the slow axis direction of the ¾ wave plate in the second circularly polarizing plate, and
the stereoscopic image display device is configured so that when the stereoscopic image display is viewed in the normal direction, the slow axis direction of the retardation plate is perpendicular to the slow axis directions of the ¼ and ¾ wave plates in the first and second circularly polarizing plates of the polarizing glasses.
